(19) United States
(12) Patent Application Publication
(10) Pub. No.: US 2005/0022240 A1
(43) Pub. Date: Jan. 27, 2005

(54) Information navigation apparatus

(75) Inventors: Shigeru Ueda, Chiba (JP); Keiko Watanuki, Ibaraki (JP); Masayuki Nakazawa, Chiba (JP)

Correspondence Address: NIXON & VANDERHYE, PC, 1100 N GLEBE ROAD, 8TH FLOOR, ARLINGTON, VA, 22201-4714, US

(73) Assignee: Sharp Kabushiki Kaisha, Osaka (JP)

(21) Appl. No.: 10/872,782

(22) Filed: Jun. 22, 2004

(30) Foreign Application Priority Data
Jun. 24, 2003 (JP) 2003-180101

(51) Int. Cl. H04N 7/025; H04N 7/173

(52) U.S. Cl. 725/46; 725/14; 725/45; 725/112; 725/110

(57) ABSTRACT

An information navigation apparatus monitors a user's preferential tendencies among huge amounts of digital content using as objective a criterion as possible, and displays content information that would facilitate the user's content selection based on the monitored data. The apparatus is capable of accommodating the user's modification of his or her preferential tendencies on the spot. The information navigation apparatus comprises a content selection history memory unit for storing a user's content selection history, a content information database for storing content information about digital content, a preference analysis unit for analyzing the user's preferences based on said content information and said user's content selection history, and display means for displaying the result of analysis of the user's preferences by said preference analysis unit.

This Nonprovisional application claims priority under 35 U.S.C. § 119(a) on patent application Ser. No. 2003-180101, filed in Japan on June, 24^{th}, the entire contents of which are hereby incorporated by reference.

### BACKGROUND OF THE INVENTION

1. Field of the Invention

The present invention relates to an apparatus and method for quantitatively analyzing a user's preferential tendencies regarding content and displaying the type of content information preferred by the user based on the result of analysis. In particular, the invention relates to an apparatus and method for analyzing a user's preferential tendencies regarding digital content that is becoming increasingly varied and complicated, and displaying the type of content information based on the result of analysis that the user can intuitively recognize, thereby providing an effective information navigation function.

2. Background Art

Digital equipment such as personal computers and DVD players are becoming increasingly common. The spread of broadband connections has triggered the advancement of high-speed networks. And a full-scale operation of digital broadcasting is about to begin. Against these backgrounds, the environment in which the users access digital content providing services is undertaking a drastic change.

Conventionally, users would watch television broadcasts on analog TV receivers, listen to music content on audio equipment, and watch video content on VCRs, with the underlying assumption that these forms of content are separate. However, now that these various forms of content are all digitally available, it is possible to handle various types of digital content on the same system thanks to the spread of personal computers, household networks, and household LANs, for example, in general households.

Specifically, it is now possible to record or view and listen to digital content from a variety of sources on the same system. Such digital content includes audio/vidual (“A/V”) content from various digital broadcasts, audio/vidual content played back from digital equipment such as digital video players or CD/MD/DVD players, A/V content played back from the hard disc in personal computers, and A/V content that is distributed on-line via the Internet.

For example, an HAVi (Home Audio Video Interoperability) system has been proposed in which a household network capable of high-speed communications is constructed in accordance with a communication standard, such as IEEE 1394 or IEEE802.b, and in which digital A/V equipment and personal computers are connected using the network and operated in a coordinated manner.

In such a digital content A/V environment, a user must select a preferred content item from huge amounts of digital content that includes content provided on a real-time basis and content that is stored in recording equipment.

If the digital content that is available is merely listed, it would take a long time for the user to search the list for desired content because of the huge amount of the available content, where the operations could be very complicated. This is analogous to the situation in regard to the electronic databases that were created in every field as a result of the development of computers, where the users used to have a hard time figuring out the nature of particular data and its storage location.

Another proposal has been to classify the digital content by types (genres) such that users can search for content based on the classification information. For example, digital content can be classified into larger categories, such as movies, music, animation, and sports, and each category can then be classified into smaller categories, such as, in the case of movies, adventures, SF, and so on, thus creating a hierarchical classification system.

In this system, when a user wishes to watch a specific movie, he or she can first select movies in the larger category, select SF movies in the smaller category, and then select the title of his or her choice from the list of SF movies that is displayed.

In this way, an A/V environment is constructed that is totally different from that involving the conventional television receivers in which viewers would select a channel he or she wishes to watch by referring to an EPG (electronic program guide).

The information navigation system disclosed in Patent Document 1 is characterized in that information is stored in a database according to categories in a hierarchical structure in order to provide the users with an appropriate information retrieval environment. In particular, FIGS. 2, 5, and 10 of Patent Document 1 show forms of the hierarchical structure according to information classifications.

As described above, by having the huge amount of digital content classified according to genres and allowing the users to search for specific content based on the classification information, the problem of a user being at a loss about how to find the content of interest from the huge amount of available content can be eliminated. However, the process of searching for and finally locating the content of interest become more complicated and time-consuming in proportion to the amount of content. In the aforementioned example, each time a user wishes to watch specific content, he or she must perform the processes of selecting a major category, a minor category, and the title of content.

The amount of such bothersome operation could be reduced by storing the information about the history of content selections made by the user and analyzing the user's content preferences based on the history information, such that the user can select content of high preference levels with a simpler operation.

In a preference data management method for digital broadcasts disclosed in Patent Document 2, program interest levels are calculated based on a history of programs a user has watched, and preference scores are calculated for each content item, using the program interest levels and content attributes allocated to the content. Content items with highest preference scores are selected as optimized content (see in particular claim 5, paragraphs 0072 to 0085, and FIG. 15)

In other examples of the prior art as well as in the preference data management method of Patent Document 2, a user's preferences are stored in terms of objective and quantitative preference data, and the user's content selection is facilitated by the preference data.

(Patent Document 1)

JP Patent Publication (Kokai) No. 9-231230 A (1997)

(Patent Document 2)

JP Patent Publication (Kokai) No. 2001-237788 A

### SUMMARY OF THE INVENTION

Since digital content includes many different types of video and audio content, it is not easy to objectively and quantitatively define its nature. No methods have been provided in the prior art that would enable the user to select items of his or her interest from various types of content based on an objective criteria in a cross-cutting manner.

Furthermore, in accordance with the prior art, the preferential tendencies are generally calculated in terms of a ratio of information selection frequency to the entire information items, based on the information selection history. In this type of calculation, the preferential tendencies can be rather accurately calculated even from a small amount of information selection history data as long as there is positive user participation. However, in general, users are free to select whatever they want to, and it is not necessarily possible to infer the grounds or reasons for particular selections based on the selection history.

Moreover, users' content preferences fluctuate constantly depending on how they are feeling on the day or even at the moment. Thus, in addition to facilitating the content selection based on the preferential tendencies determined from the analysis of past content selection history data, if the user is allowed to modify his or her preferential tendencies that are presented on the spot in order to reflect his or her instantaneous preferences on a real-time basis, higher usefulness can be achieved.

In view of the aforementioned problems of the prior art, it is the object of the invention to provide an information navigation apparatus capable of monitoring users' preferential tendencies regarding a huge amount of digital content as objectively as possible so that content information can be displayed based on the thus monitored preferential tendencies that would facilitate the users' content selection, and also capable of incorporating the users' modifications of their preferential tendencies on the spot.

After extensive research and study, the inventors arrived at the following information navigation apparatus and method.

Specifically, the invention provides an information navigation apparatus comprising:
a content information database for storing content information about digital content;
a content selection history memory unit for storing a user's content selection history; and
a preference analysis unit for analyzing the user's preferences based on the content information and the user's content selection history.

The information navigation apparatus may further comprise display means for displaying the result of analysis of the user's preferences by the preference analysis unit.

The content information may include classification information about each item of digital content.

The content information further includes information about the contents of each digital content item.

The information about the contents of each digital content item includes at least one of the items of information about the producer, cast, target age group, original writer, distributor, and country of origin.

The display means displays the result of analysis of the user's preferences using the classification information about each digital content item and at least one of the items of information about the contents.

The display means further displays available content items that match the user's preferences in accordance with the result of analysis of the user's preferences by the preference analysis unit.

The information navigation apparatus may further comprise means for allowing the user to modify the result of analysis of the user's preferences being displayed by the display means.

The digital content is acquired via digital broadcasts, Internet, externally connected digital equipment, a hard disc, or a digital recording medium.

The invention further provides an information navigation method comprising:
storing content information about digital content;
storing a user's content selection history;
analyzing the user's preferences based on the content information and the user's content selection history; and
displaying the result of analysis of the user's preferences.

The information navigation method may comprise allowing the user to modify the result of analysis of the user's preferences that is being displayed.

The invention further provides an information navigation apparatus comprising:
a preference analysis unit for analyzing a user's preferences; and
an information navigation function for facilitating the user's information selection based on the analysis performed by the preference analysis unit such that the selection of information matches the user's preferences.

According to the other aspect of this invention, the information navigation apparatus is a remote control unit or a mobile terminal which can control the other apparatus for playing and /or storing said contents.

### BRIEF DESCRIPTION OF THE DRAWINGS

FIG. 1 shows a functional block diagram of the internal structure of an information navigation apparatus according to an embodiment of the invention.

FIG. 2 shows a conceptual chart of an example of the classification structure (ontology) of digital content utilized in the present invention.

FIG. 3 shows graphs indicating a user's preferential tendencies in the information navigation apparatus of the invention. FIG. 3(a) shows a radar chart indicating the user's preferential tendencies determined by a preference analysis unit 108 based on operations performed by the user. FIG. 3(b) shows the same chart modified by the user.

### DESCRIPTION OF THE PREFERRED EMBODIMENTS

Embodiments of the invention will be described by referring to the attached drawings.

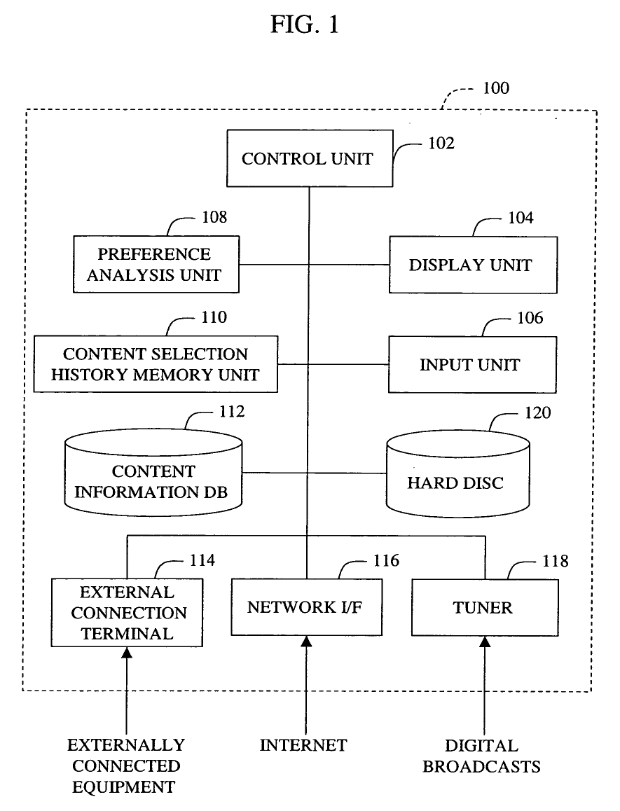

FIG. 1 shows a functional block diagram schematically illustrating the internal structure of an information navigation apparatus according to an embodiment of the invention.

An information navigation apparatus 100 of the invention comprises a control unit 102, a display unit 104, an input unit 106, a preference analysis unit 108, a content selection history memory unit 110, a content information database 112, an external connection terminal 114, a network interface 116, a tuner 118, and a hard disc 120.

The control unit 102 is an arithmetic processing unit consisting of a microcomputer, for example, that is used in general A/V equipment. It controls the operation of each constituent parts of the information navigation apparatus 100 and the data transmission between the constituent parts.

The display unit 104 includes a monitor for playing back video content and a speaker for playing back audio content, so that a user can watch and listen to digital content on the display unit 104. The monitor can also provide an OSD (On Screen Display) for information regarding the setting of the apparatus 100 and other information accompanying the digital content.

The input unit 106 receives user operations, such as the operation of an infrared remote controller, and operations performed on an operation panel provided on the surface of the apparatus 100, or via a mouse or a keyboard.

The preference analysis unit 108 analyzes the user's preference with regard to content based on information stored in the content selection history memory unit 110, which will be described later, and in the content information database 112. The preference analysis unit 108 may be constructed of a ROM (Read Only Memory) containing a predetermined program, for example.

The content selection history memory unit 110 stores the information about the content the user has watched, in terms of a content selection history. For example, it can store the date, time, the length of time of viewing, the number of times of viewing, and the source of content, for example, for each content item. It may also store other information, such as the fact that the user interrupted the playback of content.

The content information database 112 stores various information about various kinds of content that is available on the apparatus 100. For example, it may store classification information about various types of content, and meta-information about content (which will be described later). Part of the content information database 112 may utilize information that is accumulated outside the apparatus 100. For example, the content information database 112 may be adapted to acquire content information stored in a server at a content distributor.

The external connection terminal 114 is a terminal for establishing connections with external digital equipment, and it may utilize a communication standard such as IEEE1394 or USB, for example. Examples of the digital equipment connected to the apparatus 100 include a digital video player/recorder, a DVD player, a hard disc recorder, a CD player, and an MD player.

The network interface 116 is an interface for connecting the apparatus 100 to an external network, such as the Internet, in order to perform data communications. For example, the apparatus 100 may be connected to a LAN (Local Area Network) using an NIC (Network Interface Card) in accordance with Ethernet standards.

The tuner 118 is for the reception of mainly digital broadcasts and may employ a BS/CS digital broadcasts hybrid tuner, or a cable-television tuner, for example. The tuner 118 receives a digital broadcast signal from an antenna (not shown) set up outside the apparatus and converts it into a broadcast signal that can be processed in the apparatus. The tuner 118 further includes a digital broadcast signal decoder, which is not shown. In the current BS digital or terrestrial digital broadcasts, digital data of the MPEG2 format is divided into TS (Transport Stream) packets and then transmitted. These packets of the MPEG2-TS format are reassembled on the receiving end so as to acquire digital data of the MPEG2 format.

The hard disc 120 is a nonvolatile storage device such as a magnetic disc, and it can store a large volume of data, such as various forms of digital content, that is utilized in the apparatus 100. It can also store other data, such as a program necessary for the control of the apparatus 100.

The operation of the information navigation apparatus of the invention configured as described above is as follows.

A user can select a content item of his or her interest from the digital content obtained from digital broadcasts received via the tuner 118, such as those received from externally connected digital equipment via the external connection terminal 114, or from the Internet connected via the network interface 116, and the digital content stored in the hard disc 120 in the apparatus 100. The selected content item can be displayed on the display unit 104 for viewing.

These forms of digital content are handled in a predetermined common data format in the apparatus 100. Specifically, the apparatus may utilize the MPEG format, which is a digital data compression format widely utilized for digital broadcasts and DVDs, for example. In particular, the MPEG2 format may be employed for video content such that the video content can be played back at data transmission rates of the order of 4 to 15 Mbps for both video and audio combined and with a picture quality comparable to that of S-VHS video.

When the user selects a favorite piece of content from the aforementioned digital content, a content selection screen is OSD-displayed on the display unit 104. For digital broadcast content, a conventional EPG (Electronic Programming Guide) can be displayed. For the Internet content, the title list of a particular Web site can be displayed as is. In cases where a DVD player is employed as externally connected equipment, a predetermined DVD menu screen is displayed. With regard to the digital content stored in the hard disc 120, the content selection screen can be displayed based on a predetermined content list display program, for example. Alternatively, the apparatus 100 may be furnished with a program that allows a search for digital content available from these different content sources so that a list of all available content items can be displayed.

As the user selects a content item, the control unit 102 outputs the content item to the display unit 104 and causes the content selection history memory unit to store information about the particular content.

Hereafter, a feature of the information navigation apparatus of the invention, namely the function for displaying content information in accordance with the user's preferential tendencies, will be described.

In response to the user's operations, the preference analysis unit 108 determines the user's content preferential tendencies by referring to the user content selection history stored in the content selection history memory unit 110 and to the information about the content stored in the content information database 112. The information about content and a method of utilizing the same will be described below.

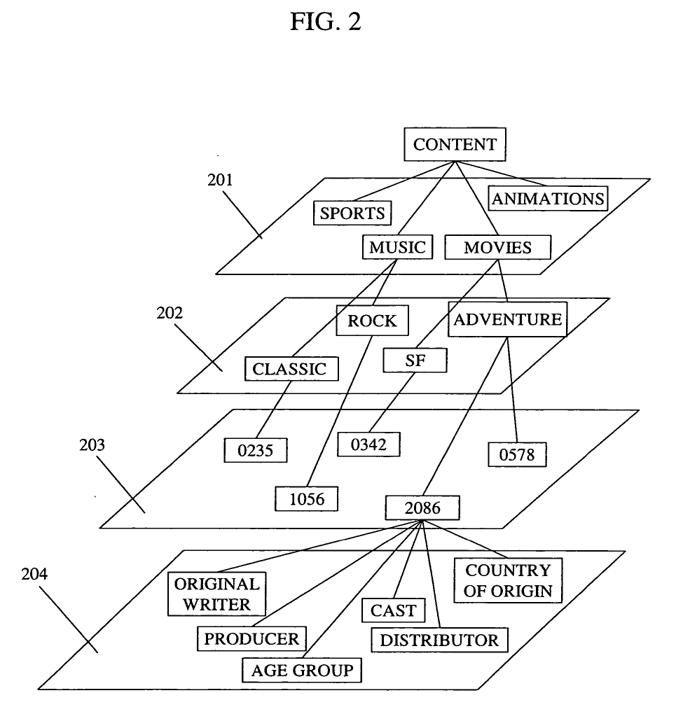

FIG. 2 shows a conceptual chart of an example of the digital content classification structure (ontology) utilized in the present invention.

In FIG. 2, all of the digital content is classified into a major category (genre) 201 and a minor category (sub-genre) 202. Individual content items are identified by content ID 203. Each content ID 203 is associated with content meta-information 204. These pieces of digital content classification information are stored in the content information database 112 in the information navigation apparatus according to the invention.

The digital content classification method should be standardized as much as possible so as to perform classification uniformly based on that standard, as the method provides an important indicator during the selection of content. For example, the method may utilize an ontology according to MPEG-7 of ISO/SC29, which has already been established as an international standard, or MPEG-21, which is a standard under development. In Japan, there is an industrial-educational organization called content ID forum (cIDf), which is working to create a content ID allocation standard for digital content which is based on a combination of a unique code and content meta-information.

As a classification system for a variety of kinds of information on the Web, the Web Ontology Language (OWL) has been established by W3C. The OWL describes resources using a RDF (Resource Description Framework) model and an RDF schema in order to define the classification systems (classes) for various information on the Web and their relationships, as well as rules for inferring them. The Web Ontology Language is expected to allow vocabularies uniquely defined in different localities to be related to one another such that they can be mutually operated or to allow agents to perform sophisticated searches using the knowledge represented by the ontology.

In the content classification structure shown in FIG. 2, the term “meta-information” refers to information about information. For example, it refers to information about ways of using information, or information about the characteristics of information. Namely, the meta-information is information about each content item (e.g., information about the producer, cast, the target age group, original writer, distributor, and the country of origin). These pieces of information are distributed together with the content data in accordance with the aforementioned standard.

By utilizing the meta-information provided by the distributor of the digital content, it becomes possible to conduct reliable searches on digital content, on which, in contrast to text data, it is difficult to perform mechanical semantic processing, based on the ontology relating to the format and contents of the digital content.

Moreover, in cases where huge amounts of various kinds of digital content are accumulated as a result of the increase in the storage capacity of the storage device owned by the user, such as a hard disc, it becomes possible to conduct searches using the ontology on the different kinds and formats of content in a cross-cutting manner.

Furthermore, a menu or a ranking that recommends content items adapted to the user's preferences can be presented on the basis of the user's preferences that are registered in advance and the currently available content.

The information navigation apparatus of the invention is characterized in that it can display, in the form of a graph, the top five items, for example, of the meta-information items of the content items extracted as representing the user's preferential tendencies, and that the user can directly modify the graph that is being displayed by himself or herself as necessary.

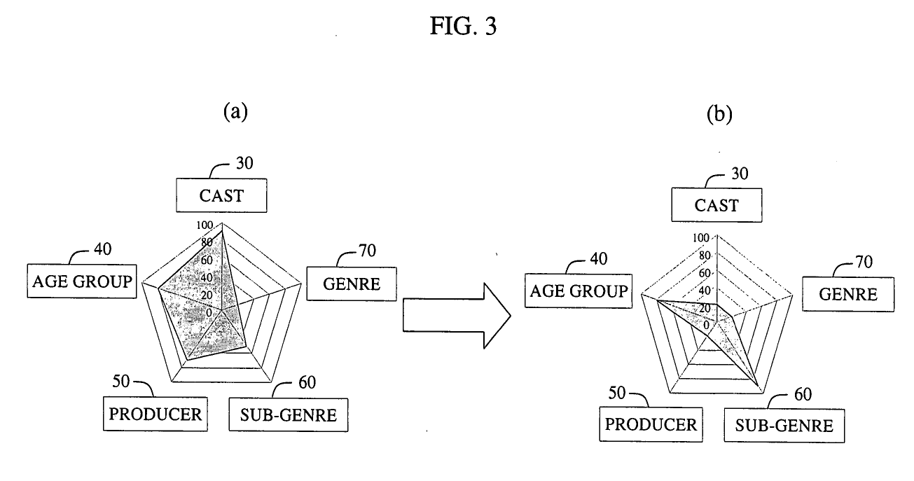

FIG. 3 shows an example of the graph of the user's preferential tendencies in the information navigation apparatus of the invention. In the figure, the user's preferential tendencies are indicated by a radar chart consisting of five meta-information items. However, this is merely an example and other forms of display, such as in terms of a table or texts, may be employed.

FIG. 3(a) shows a radar chart indicating the user's preferential tendencies determined by the preference analysis unit 108 based on the user's operations. The figure shows five items with various scores, namely, cast 30, age group 40, producer 50, sub-genre (minor category) 60, and genre (major category) 70 with decreasing scores. Thus the graph indicates that the user shows the strongest preferential tendencies with regard to the meta-information of the cast 30 and the weakest preferential tendencies toward the genre 70.

If the user acknowledges the preferential tendencies shown in FIG. 3(a), the information navigation apparatus of the invention searches currently available content items based on these preferential tendencies and then displays several content item recommendations to the user.

On the other hand, if the user wishes to modify the preferential tendencies shown in FIG. 3(a), he or she can freely modify the score for each item in the radar chart by operating the cursor or the like via the input unit 106. For example, the preferential tendencies could be modified to those shown in FIG. 3(b).

Thus, the user can modify his or her preferential tendencies determined by the preference analysis unit 108 depending on his or her own feelings on the day or at the particular moment, such that the content search or recommendations can more accurately reflect the user's preferences.

While the information navigation apparatus of the invention has been particularly shown and described with reference to preferred embodiments thereof, it will be understood by those skilled in the art that the foregoing and other changes in form and details can be made therein without departing from the spirit and scope of the invention.

For example, the information navigation apparatus of the invention may be similarly adapted for net shopping or advertisement distribution purposes, rather than for digital content.

The information navigation apparatus could be a remote control unit or a mobile terminal which can control the other apparatus for playing and /or storing said contents.

As described above, in accordance with the information navigation apparatus of the invention, the user's preferential tendencies among huge amounts of digital content can be monitored using as objective a criterion as possible, so that content information that would facilitate the user's content selection can be displayed based on the monitored data. Moreover, the apparatus is adapted to accommodate the user's intuitive modification of his or her preferential tendencies on the spot, thereby allowing a search of content or content recommendations to be adapted to the user's feelings on a particular day or at a particular moment.

1. An information navigation apparatus comprising:
a content information database for storing content information about digital content;
a content selection history memory unit for storing a user's content selection history; and
a preference analysis unit for analyzing the user's preferences based on said content information and said user's content selection history.

2. The information navigation apparatus according to claim 1, further comprising display means for displaying the result of analysis of the user's preferences by said preference analysis unit.

3. The information navigation apparatus according to claim 1, wherein said content information includes classification information about each item of digital content.

4. The information navigation apparatus according to claim 3, wherein said content information further includes information about the contents of each digital content item.

5. The information navigation apparatus according to claim 4, wherein said information about the contents of each digital content item includes at least one of the items of information about the producer, cast, target age group, original writer, distributor, and country of origin.

6. The information navigation apparatus according to claim 4, wherein said display means displays the result of analysis of the user's preferences using the classification information about each digital content item and at least one of the items of information about the contents.

7. The information navigation apparatus according to claim 1, wherein said display means further displays available content items that match the user's preferences in accordance with the result of analysis of the user's preferences by said preference analysis unit.

8. The information navigation apparatus according to claim 1, further comprising modification means for allowing the user to modify the result of analysis of the user's preferences being displayed by said display means.

9. The information navigation apparatus according to claim 1, wherein the digital content is acquired via digital broadcasts, Internet, externally connected digital equipment, a hard disc, or a digital recording medium.

10. An information navigation method comprising:
storing content information about digital content;
storing a user's content selection history;
analyzing a user's preferences based on said content information and the user's content selection history; and
displaying the result of analysis of said user's preferences.

11. The information navigation method according to claim 10, further comprising allowing said user to modify the result of analysis of the user's preferences that is being displayed.

12. An information navigation apparatus comprising:
a preference analysis unit for analyzing a user's preferences; and
an information navigation function for facilitating the user's information selection based on the analysis performed by said preference analysis unit such that the selection of information matches the user's preferences.

13. The information navigation apparatus according to claim 7, further comprising requesting means for requesting said available content being displayed by said display means.

14. The information navigation apparatus according to claim 13, further comprising means for indicating a treatment about the contents requested using said requesting means.

15. The information navigation apparatus according to claim 8, said modification means to modify the preference by referring to said user's preferences being displayed by said display means.

16. The information navigation apparatus according to claim 8, said display means display newly available contents, which acquired by said preference analysis unit based on said modified user's preference using said modification means.

17. The information navigation apparatus according to claim 1, wherein said database has a tree structure, wherein the tree structure has a content upstream and factors of preferences downstream which concerns and introduces to said content.

18. The information navigation apparatus according to claim 17, wherein the display means displays the newly available contents acquired from said tree structures based on the modified factors of preference.

19. The information navigation apparatus according to claim 1, wherein said apparatus is a remote control unit or a mobile terminal which can control the other apparatus for playing and /or storing said contents.

20. An information navigation apparatus comprising:
a content selection history memory unit for storing a user's content selection history; and
a preference analysis unit for analyzing the user's preferences based on the digital contents information acquired from the outside of said information navigation apparatus and said user's content selection history.
